(19) United States
(12) Patent Application Publication
(10) Pub. No.: US 2015/0034466 A1
(43) Pub. Date: Feb. 5, 2015

(54) BUTTON ASSEMBLY OF AUTOMATIC VENDING MACHINE

(71) Applicant: HON HAI PRECISION INDUSTRY CO., LTD., New Taipei (TW)

(72) Inventor: YUN-LUNG CHEN, New Taipei (TW)

(21) Appl. No.: 14/445,452

(22) Filed: Jul. 29, 2014

(30) Foreign Application Priority Data
Jul. 30, 2013 (CN) 2013103245966

(51) Int. Cl. H01H 13/50

(52) U.S. Cl. CPC H01H 13/50; H01H 2233/03
USPC 200/345

(57) ABSTRACT

A button assembly includes a switch, a button, and a resilient cushion. The switch includes a key. The resilient cushion includes a connecting portion, an abutting portion connected to the connecting portion, and a resilient portion connected to the connecting portion. The connecting portion defines an opening, the abutting portion defines a receiving space communicating with the opening, so that the key extends through the opening to be located in the receiving space. The resilient portion and the abutting portion are received in the button, and the button is moveable to press the abutting portion and deform the resilient portion, for allowing the abutting portion to press the key.

### FIELD

The present disclosure relates to button assemblies, and particularly to a button assembly used for an automatic vending machine.

### BACKGROUND

Automatic vending machines include decorating plates and a plurality of button assemblies attached to the decorating plates. A button assembly can include a securing panel, a button attached to the securing panel, an extending arm, and a rib. The button is secured to the decorating plate by a soldering process, and the rib is connected to the button by the extending arm. In use, when the button is pressed, the extending arm is deformed to move the rib to open or close an electrical connection of the vending machine.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a button assembly.

FIG. 2 is similar to FIG. 1, but viewed from a different angle.

FIG. 3 is an assembled view of the button assembly of FIG. 1.

FIG. 4 is a cross-sectional view of FIG. 3, taken along line IV-IV, wherein a button of the button assembly is in a first position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

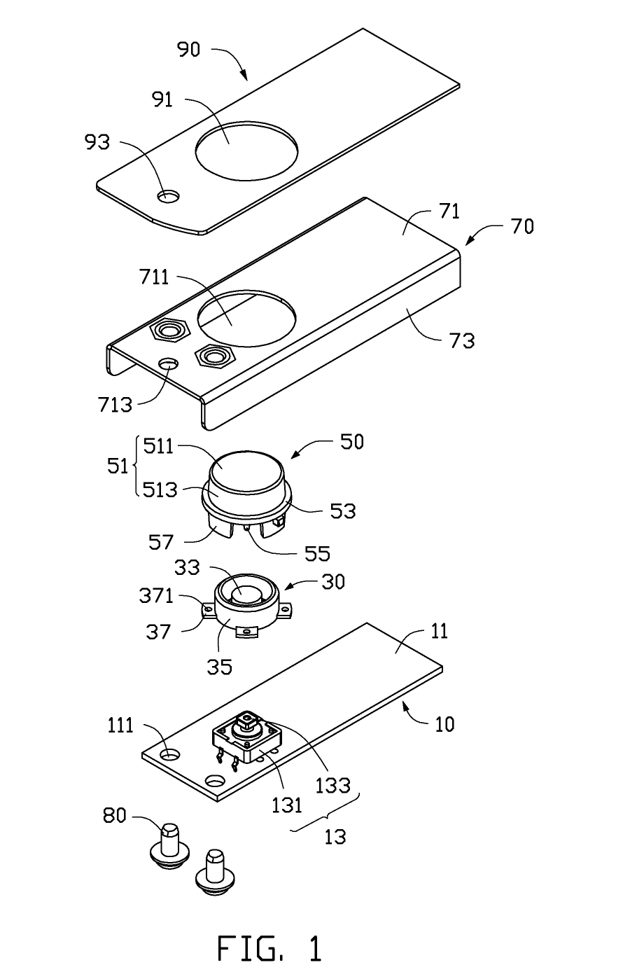

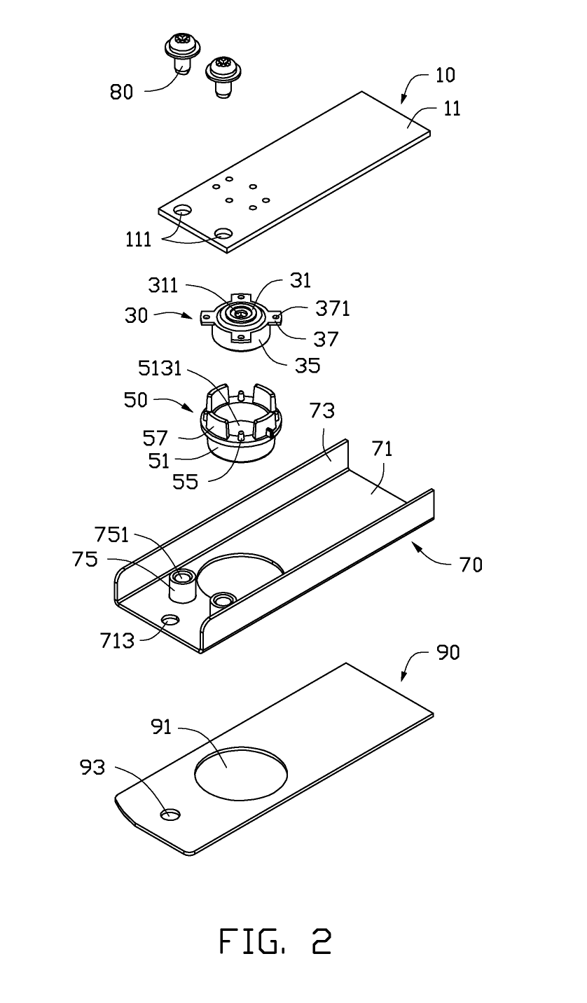

FIGS. 1-2 illustrate an embodiment of a button assembly. The button assembly comprises a circuit board 10, a resilient cushion 30, a button 50, a securing tray 70, and a cover 90.

The circuit board 10 comprises a base body 11 and a switch 13 located on the base body 11. The switch 13 comprises a mounting frame 131 and a key 133 located in the mounting frame 131. The switch 13 can be powered on or powered off by the key 133.

Two mounting holes 111 are defined in the base body 11 and adjacent to the switch 13.

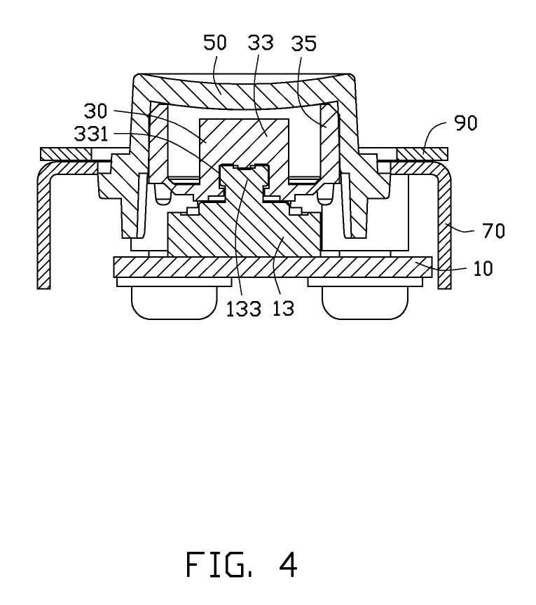

The resilient cushion 30 comprises a connecting portion 31, a abutting portion 33 connected to the connecting portion 31, a resilient portion 35 extending from the connecting portion 31, and four positioning portions 37 extending from the connecting portion 31. The resilient portion 35 is hollow and surrounds the abutting portion 33. Each positioning portion 37 defines a positioning hole 371. An opening 311 is defined in the center of the connecting portion 31. A receiving space 331 (see FIG. 4) is defined in the abutting portion 33 and communicates with the opening 311. In one embodiment, the resilient cushion 30 is plastic.

The button 50 comprises a main body 51, a flange 53 extending around a peripheral end portion of the main body 51, four positioning posts 55, and four resisting portions 57. The four positioning portions 55 are used to extend through the positioning portions 371. The main body 51 comprises a pressing portion 511 and an extending portion 513 extending from the pressing portion 511. The extending portion 513 is hollow and defines a housing passage 5131. The four positioning posts 55 and the four resisting portions 57 extend from the extending portion 513.

The securing tray 70 comprises a securing plate 71, two side plates 73 extending opposite edges of the securing plate 71, and two securing posts 75 extending from a bottom surface of the securing plate 71. The securing plate 71 defines a fixing hole 711 and a through hole 713. Each securing post 75 defines a securing hole 751 corresponding to the mounting holes 111.

The cover 90 defines a retaining opening 91 and a fastening hole 93. The retaining opening 91 corresponds to the fixing hole 711, and the fastening hole 93 corresponds to the through hole 713.

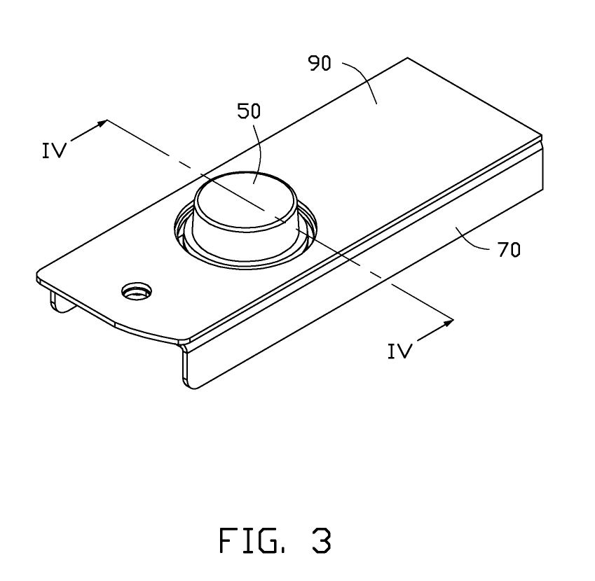

FIGS. 1-4 illustrate that when the button assembly is in an assembled configuration. The abutting portion 33 and the resilient portion 35 are received in the housing passage 5131, and the positioning posts 55 extend through the corresponding positioning holes 3171 to engage the button with the resilient cushion 30. The resilient cushion 30 is located on the switch 13, and the key 133 extends through the opening 311 to position in the housing passage 331 engaging the switch 13 to the resilient cushion 30. The cover 90 abuts a top surface of the securing plate 71, the retaining opening 91 is aligned with the fixing hole 711, and the fastening hole 93 is aligned with the through hole 713. A fixing member (not visible) is engaged in the through hole 713 and the fastening hole 93 to secure the cover 90 to the securing tray 70. The button 50 extends through the fixing hole 711 and the retaining opening 91 to be exposed out of the cover 90. The two securing posts 75 are resisted on the circuit board 10, and the two securing holes 751 are aligned with the mounting holes 111. Two fastening members 80 are engaged in the tow securing holes 751 and the mounting holes 111, thus, the circuit board 10 is secured to the securing tray 70.

In use, the pressing portion 511 is pressed in a first direction that is substantially perpendicular to the circuit board 10 to resist the resilient portion 35 and the abutting portion 33, so that the abutting portion 33 can move towards the circuit board 10 to press the key 133. The four resisting portions 57 support on the circuit board 10 to prevent the button 50 from further moving in the first direction. The resilient portion 35 is deformed. When the pressing portion 511 is not pressed, the resilient portion 35 is released to move the button 50 in a second direction that is opposite to the first direction.

Even though numerous characteristics and advantages have been set forth in the foregoing description of embodiments, together with details of the structures and functions of the embodiments, the disclosure is illustrative only and changes may be made in detail, including in the matters of shape, size, and arrangement of parts. The disclosed embodiments are illustrative only, and are not intended to limit the scope of the following claims.

What is claimed is:

1. A button assembly comprising:
a switch comprising a key;
a button; and
a resilient cushion comprising a connecting portion, an abutting portion connected to the connecting portion, and a resilient portion connected to the connecting portion; the connecting portion defining an opening, and the abutting portion defining a receiving space communicating with the opening; the key extending through the opening to be located in the receiving space,
wherein the resilient portion and the abutting portion are received in the button, and the button is moveable to press the abutting portion and deform the resilient portion, thereby enabling the abutting portion to press the key.

2. The button assembly of claim 1, wherein the button comprises a pressing portion and an extending portion extending from the pressing portion, the extending portion is hollow, and the resilient portion and the abutting portion are received in the extending portion.

3. The button assembly of claim 2, wherein the resilient cushion further comprises a positioning portion, the button further comprises a positioning post, and the positioning post is engaged with the positioning portion.

4. The button assembly of claim 3, wherein the positioning portion is substantially perpendicular to the resilient portion and defines a positioning hole, and the positioning post is engaged in the engaging hole.

5. The button assembly of claim 2, further comprising a circuit board for securing the switch, wherein the button further comprises a resisting portion extending from the extending portion, and wherein when the button is movable in a first direction, the resisting portion is resisted on the circuit board for preventing the button from moving in the first direction.

6. The button assembly of claim 1, further comprising a securing tray and a cover attached to the securing tray, wherein the securing tray is secured to the circuit board, and the button extends through the securing tray and is exposed out of the cover.

7. The button assembly of claim 6, wherein the securing tray defines a fixing hole, the cover defines a retaining opening aligned with the fixing hole, and the button extends through the fixing hole and the retaining opening.

8. The button assembly of claim 7, wherein the securing tray comprises a securing plate and two side plates substantially perpendicular to the securing tray, and the fixing hole is defined in the securing plate.

9. The button assembly of claim 8, wherein a positioning post is located on the securing plate and support on the circuit board, the positioning post defines a positioning hole, a mounting hole is defined in the circuit board, and a fastening member is engaged in the mounting hole and the positioning hole to secure the circuit board to the securing tray.

10. A button assembly comprising:
a circuit board;
a switch attached to the circuit board and comprising a key;
a button defining a housing passage; and
a resilient cushion secured to button and comprising a connecting portion, an abutting portion connected to the connecting portion, and a resilient portion connected to the connecting portion; the resilient portion and the abutting portion received in the housing passage; the key extending through the connecting portion to be located in the abutting portion;
wherein the button is moveable towards the circuit board to press the abutting portion and deform the resilient portion, thereby enabling the abutting portion to press the key.

11. The button assembly of claim 10, wherein the connecting portion defines an opening, the abutting portion defines a receiving space communicating with the opening, and the key extends through the opening to be located in the receiving space.

12. The button assembly of claim 10, wherein the resilient cushion further comprises a positioning portion, the button further comprises a positioning post, and the positioning post is engaged with the positioning portion.

13. The button assembly of claim 12, wherein the positioning portion is substantially perpendicular to the resilient portion and defines a positioning hole, and the positioning post is engaged in the engaging hole.

14. The button assembly of claim 10, wherein the button further comprises an extending portion, the resisting portion extending therefrom, and wherein when the button is movable in a first direction, the resisting portion is resisted on the circuit board for preventing the button from moving in the first direction.

15. The button assembly of claim 10, further comprising a securing tray and a cover attached to the securing tray, wherein the securing tray is secured to the circuit board, the button extends through the securing tray, and is exposed out of the cover.

16. The button assembly of claim 15, wherein the securing tray defines a fixing hole, the cover defines a retaining opening aligned with the fixing hole, and the button extends through the fixing hole and the retaining opening.

17. The button assembly of claim 16, wherein the securing tray comprises a securing plate and two side plates substantially perpendicular to the securing tray, and the fixing hole is defined in the securing plate.

18. The button assembly of claim 17, wherein a positioning post is located on the securing plate and support on the circuit board, the positioning post defines a positioning hole, a mounting hole is defined in the circuit board, and a fastening member is engaged in the mounting hole and the positioning hole to secure the circuit board to the securing tray.
